(19) United States
(12) Patent Application Publication
(10) Pub. No.: US 2014/0139742 A1
(43) Pub. Date: May 22, 2014

(54) METHODS AND SYSTEMS FOR DISPLAYING ADVERTISEMENTS

(71) Applicant: UNITED VIDEO PROPERTIES, INC., Santa Clara, CA (US)

(72) Inventors: Sreeram Krishna, San Jose, CA (US); Michael Nichols, La Canada, CA (US)

(73) Assignee: UNITED VIDEO PROPERTIES, INC., Santa Clara, CA (US)

(21) Appl. No.: 13/680,664

(22) Filed: Nov. 19, 2012

(51) Int. Cl. H04N 5/45

(52) U.S. Cl. CPC H04N 5/45
USPC 348/565

(57) ABSTRACT

Methods and systems are described herein for continuing the display of an advertisement in a display window in response to a user accessing a different media asset while the advertisement is being displayed. In some embodiments, the different media asset is displayed simultaneously with the advertisement in the display window, until the advertisement is completed.

### BACKGROUND OF THE INVENTION

In conventional systems, advertisements or commercials presented to users provide the funding means for a variety of media assets. Television broadcasts, streaming internet media, and even some on-demand programs are supported by commercials or advertisements shown during their play lengths. To prevent users from becoming irritated, or from losing interest in the program, commercials are typically displayed only during commercial breaks. Each commercial break typically shows several advertisements and lasts for a few minutes.

In an effort to prevent users from changing channels or switching to other media assets, conventional systems often distribute the advertisements or commercial breaks throughout the play length of the media asset. However, given the plethora of content options currently available to a user, users are still likely to change channels or select new media assets when an advertisement is displayed. Moreover, given the rise of DVR technology, users are increasingly fast-forwarding through advertisements. While accessing different content or fast-forwarding through advertisements may appeal to users, advertisers, and content providers which are funded by the advertisers, are negatively affected. The advertisers depend on users viewing the advertisements, and user actions decreasing the amount of advertisements viewed, decreases revenues resulting from advertisements.

### SUMMARY OF THE DISCLOSURE

Accordingly, methods and systems are described herein for continuing the display of an advertisement in a display window in response to a user accessing a different media asset while the advertisement is being displayed. In some embodiments, the different media asset is displayed simultaneously with the advertisement in the display window, until the advertisement is completed.

Importantly, this disclosure strikes a delicate balance by appeasing both users and advertisers. Users benefit by being able to enjoy media assets as they wish, and advertisers are ensured that users will still view (albeit only in a display window) their advertisements, which provide the funding for the media assets enjoyed by the users.

For example, a media guidance application may receive a request to display a program on a display screen of a user device. The media guidance application may also determine that an advertisement is being displayed on the display screen based on flags transmitted with the advertisement. If the media guidance application receives a request from a user to access a different program (e.g., a channel change request), while the advertisement is being displayed, the media guidance application may transmit an instruction to display the different program with a display window, which includes the remainder of the advertisement. After the advertisement has concluded, the display window may disappear from the display screen automatically.

In another example, while viewing a program, a media guidance application may receive a request from a user to perform a fast-access playback operation (e.g., fast-forwarding, skipping, rewinding, etc.) during an advertisement. In response the media guidance application may transmit an instruction to display the advertisement in a display window (e.g., a Picture-In-A-Picture (“PIP”) display, an on-screen banner, and/or a split screen display).

For example, while the user is fast-forwarding, the media guidance application may transmit an instruction to display the advertisement in a display window. In some embodiments, the media guidance application may also continue displaying the advertisement after the user has resumed viewing the program (i.e. stopped fast-forwarding).

In some embodiments, the sound associated with both the advertisement and the program may be heard. In some embodiments, the sound associated with the display window may be removed or replaced with subtitles while the advertisement is displayed in the display window.

In some embodiments, the media guidance application may determine when to remove the display window featuring one or more advertisements based on a predetermined time limit and/or based on the number of advertisements that were displayed. For example, if the advertisements were scheduled to be displayed, the media guidance application may terminate the display window only after all three advertisements are displayed.

In some embodiments, the media guidance application may determine when to remove the display window based on the amount of time between receiving user inputs requesting the display of different media assets. For example, the media guidance application may continue to display the display window as a user scans through different programs, upon determining that the user has stopped scanning (e.g., the user has decided upon a particular different program to watch), the media guidance application may remove the display window.

Additionally or alternatively, the media guidance application may pause the display of the advertisement in the display window while the user scans through different programs. When the user has stopped scanning (e.g., a predetermined amount of time has been reached between user inputs), the media guidance application generates an instruction to continue the display of the advertisement in the display window.

In some embodiments, the media guidance application may display the advertisement on a second screen device. For example, if the user is accessing a program on his or her computer, the media guidance application may display the remainder of the advertisement on a mobile device associated with the same user, while a newly accessed program is displayed on his or her computer.

It should be noted, the systems and/or methods described above may be applied to, or used in accordance with, other systems, methods and/or apparatuses.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative media guidance application that may be used to display media assets and advertisements in accordance with some embodiments of the disclosure;

FIG. 2 shows an illustrative media guidance application that may be used to display media assets and advertisements in different portions of a display screen in accordance with some embodiments of the disclosure;

FIG. 3 is a block diagram of an illustrative user equipment device in accordance with some embodiments of the disclosure;

FIG. 4 is a block diagram of an illustrative media system in accordance with some embodiments of the disclosure;

FIG. 5A is an illustrative timeline describing the events occurring at different points in time on a display screen displaying media assets and advertisements in accordance with some embodiments of the disclosure;

FIG. 5B is an illustrative timeline showing the appearance of a display screen displaying media assets and advertisements at various points in time in accordance with some embodiments of the disclosure;

FIG. 6 is a flowchart of illustrative steps for displaying one or more advertisements in a display window in response to a user request to access a second media asset during the display of an advertisement in accordance with some embodiments of the disclosure;

FIG. 7 is a flowchart of illustrative steps for determining when to remove the display of an advertisement display in a display window in accordance with some embodiments of the disclosure; and

FIG. 8 is a flowchart of illustrative steps for displaying an advertisement in a display window in response to a fast-access playback operation during an advertisement in accordance with some embodiments of the disclosure.

### DETAILED DESCRIPTION OF DRAWINGS

Methods and systems are described for continuing the display of advertisements in a display window on a display screen in response to a request by the user to modify the display of an advertisement. For example, in order to ensure that a user views an advertisement associated with a media asset, the media guidance application may transmit additional instructions to generate a display window featuring the advertisement upon receiving a request from a user to access a different media asset or perform a fast-access playback operation during the advertisement. For example, the media guidance application may transmit an instruction to continue the display of the advertisement in a PIP display, while the user views a different media asset or while the user views content resulting from the fast-access playback operation.

An application that provides the functions described above is referred to herein as an interactive media guidance application or, sometimes, a media guidance application or a guidance application.

As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

It should be noted that any embodiment relating to the display of one advertisement may also be applied to the display of several advertisement. For example, advertisements are often displayed in a group (e.g., a commercial break). As described herein, a user request to access a different media asset during a particular advertisement in the advertisement group may result in the display of one or more of the advertisements in the group being displayed in the display window. For example, is a user requests a different media access during the display of the first advertisement in an advertisement group containing three advertisements, all three advertisements may be displayed in the generated display window. Additionally or alternatively, if a user views the first advertisement and then accesses a different media asset during the second advertisement, only the non-viewed advertisements (e.g., the second and third advertisement) may be displayed in the generated display window.

As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same.

In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a website), or as stand-alone applications or clients on user equipment devices. Various devices and platforms that may implement media guidance applications are described in more detail below.

Throughout this disclosure, embodiments feature generating a display window based on various user inputs. It should be noted that any embodiment featuring one type of user input could be applied to, or substituted or combined with, embodiments featuring other types of user inputs. For example, in response to any user input that results in a modification of a display of the advertisement (e.g., any action initiated by a user input, which may result in the advertisement not being displayed as intended by the creator of the advertisement), the media guidance application may transmit an instruction to generate a display window featuring the advertisement. For example, a modification may include, but is not limited to, accessing a different media asset (e.g., changing a channel), performing a fast-access playback operation during an advertisement, minimizing a screen displaying an advertisement, and/or opening an overlay, which obscures part of the advertisement.

As referred to herein, the phrase “fast-access playback operations” should be understood to mean any operation that pertains to playing back a non-linear media asset faster than normal playback speed or in a different order than the media asset is designed to be played, such as a fast-forward, rewind, skip, chapter selection, segment selection, skip segment, jump segment, next segment, previous segment, skip advertisement or commercial, next chapter, previous chapter or any other operation that does not play back the media asset at normal playback speed. The fast-access playback operation may be any playback operation that is not “play,” where the play operation plays back the media asset at normal playback speed.

One of the functions of the media guidance application is to provide media guidance data to users. As referred to herein, the phrase, “media guidance data” or “guidance data” should be understood to mean any data related to media assets (or advertisements), such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

In some embodiments, media guidance data may include flags, tags, code, or other signals that may be detected by the media guidance application to indicate the beginning, termination, and/or display of an advertisement and/or media asset. In some embodiments, media guidance data may indicate to the media guidance application when a media asset or advertisement begins or terminates. It should be noted that other suitable methods for detecting when a media asset and/or advertisement begins and/or terminates (e.g., blank frame detection, scene change detection, and/or logo detection) are contemplated by this disclosure.

In some embodiments, a media asset and an advertisement may be transmitted and/or buffered separately. In such embodiments, the media guidance application may determine when the display, transmission, and/or buffering of the media asset and/or advertisement begins or terminates. For example, in some embodiments, a media asset may be streamed to user equipment. During an advertisement, the media asset may not be streamed, and instead an advertisement may be streamed. The media guidance application may detect when the media asset and/or the advertisement are streamed, in order to determine whether or not a user action occurred during an advertisement.

In some embodiments, the media guidance data may also instruct the media guidance application as to the length of a scheduled advertisement break (e.g., a period of time during which the media asset is interrupted so that one or more advertisements may be shown). The length of the scheduled advertisement break may be measured in an amount of time or in an amount/number of advertisements during the advertisement break. In some embodiments, the media guidance application may also use this information to determine if a user input is received during the display of an advertisement. In some embodiments, the length of a scheduled advertisement may form the basis for determining when a display window featuring one or more advertisements should be removed. For example, if the media guidance application determines that a user request to access a new media asset or perform a fast-access playback operation is received during an advertisement, the media guidance application may determine when to remove the display window based on the amount of time a user has viewed the advertisement and/or the media asset.

For example, if the user has only briefly viewed the media asset before an advertisement began, the media guidance application may determine that a display window should not be generated. In some embodiments, this decision may be based on data in a user profile or media guidance data.

In some embodiments, media guidance data may further instruct the media guidance application on what factors should be used to determine when to remove a display window. For example, in some embodiments, after receiving the user input requesting a new media asset during the display of an advertisement, the media guidance application may determine when to remove the display window featuring the advertisement based on one or more factors (e.g., the type of device the user is using to access the media asset or whether or not a user is currently scanning through different media assets).

For example, the media guidance application may continue to display the advertisement as a user scans through different programs. Upon determining that the user has stopped scanning (e.g., a predetermined amount of time has elapsed between two user inputs requesting two different media assets), the media guidance application may remove the display window featuring one or more advertisements.

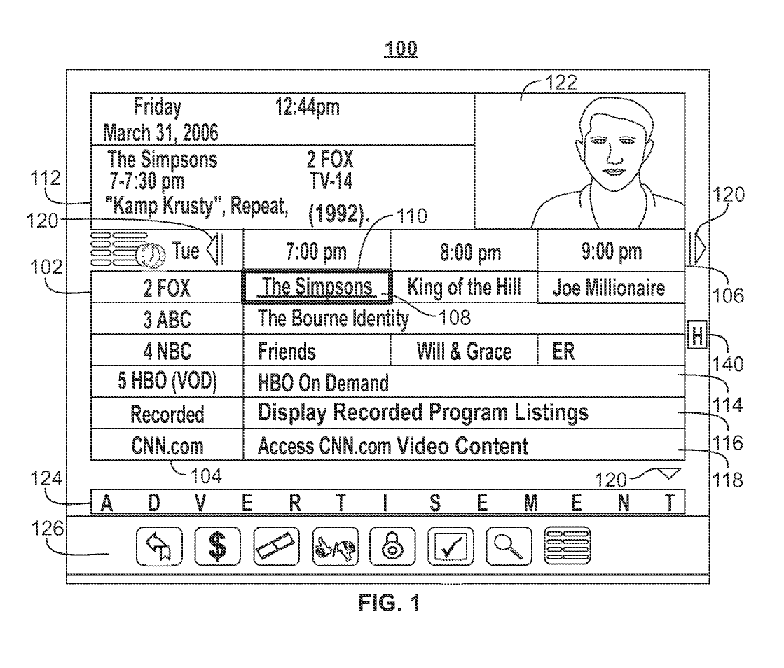

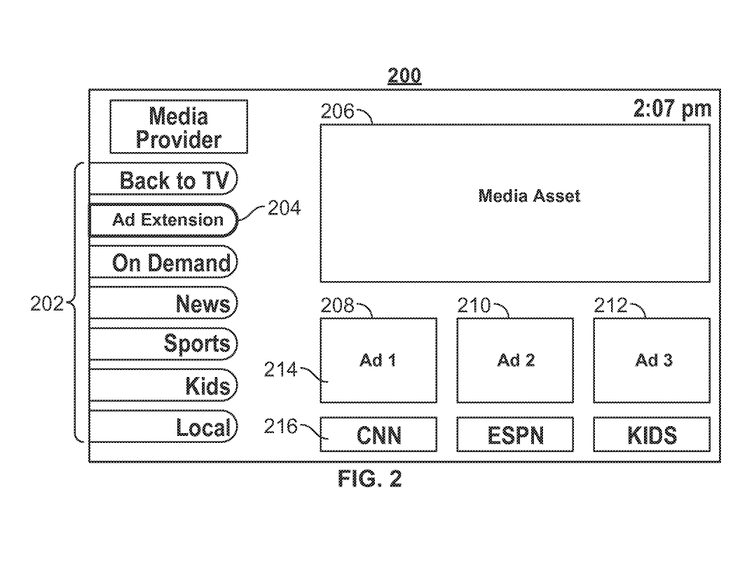

FIGS. 1-2 show illustrative display screens that may be used to provide media guidance data. The display screens shown in FIGS. 1-2 and 5A-B may be implemented on any suitable user equipment device or platform. While the displays of FIGS. 1-2 and 5 A-B are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet website or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different from display 100 may be based on user selection or guidance application definition (e.g., a display of only recorded and broadcast listings, only on-demand and broadcast listings, etc.).

As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above.

Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other airtimes or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

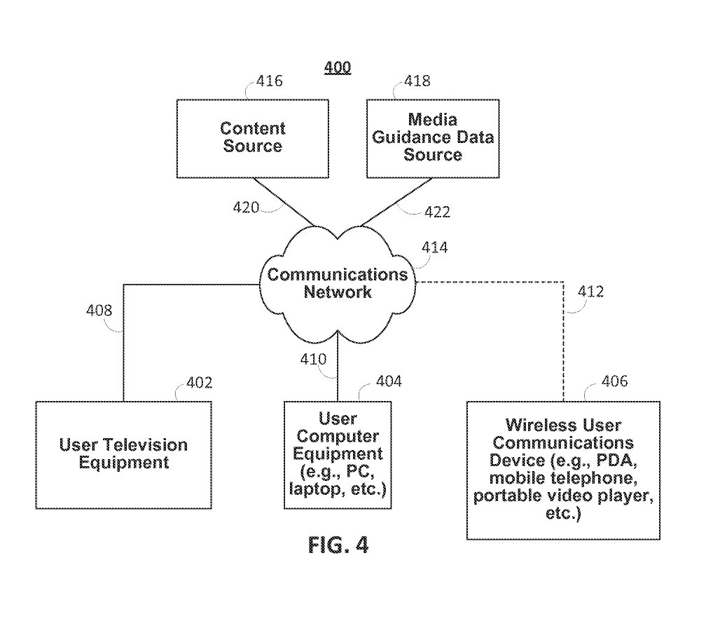

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other websites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for settings and content information organized based on content type, genre, and/or other organization criteria. In display 200, option 204 is selected. Option 204 indicates to the media guidance application to implement advertisement extensions while viewing media assets. For example, by selecting option 204, the media guidance application may continue to display advertisements from a first media asset after the user changes to a second media asset. Display 200 shows a split screen format in which the display of listing 206 is reduced from a full-screen format to allow the advertisement extension of previously viewed listings (e.g. listings 208, 210, and 212) to be displayed.

In some embodiments, the selection of option 204 may reduce the number of advertisements that are displayed to a user. For example, in exchange for allowing advertisement extensions to be displayed, a user may have the length of one or more advertisements or advertisement breaks shortened. Additionally or alternatively, in exchange for allowing advertisement extensions to be displayed, a user may receive a reduction in the cost of the programming.

In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

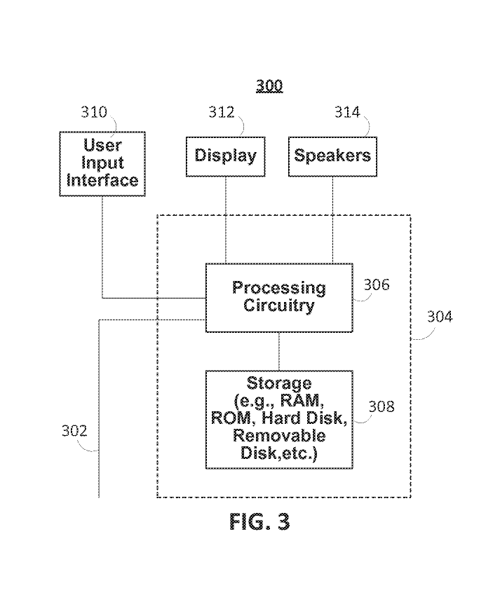

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which are described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a stand-alone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a website accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

In some embodiments, if the media guidance application receives a user input requesting a modification to the display of an advertisement, the media guidance application may display the remainder of the advertisement on a second screen device and may display any program associated with the advertisement on a first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the website www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. YouTube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

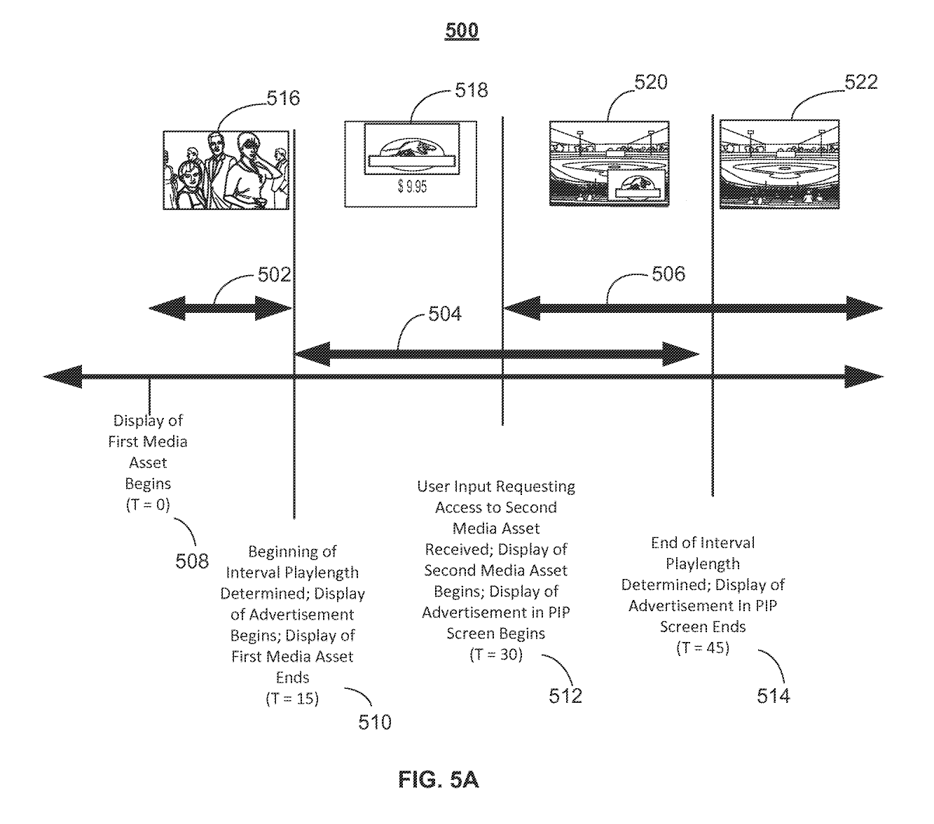

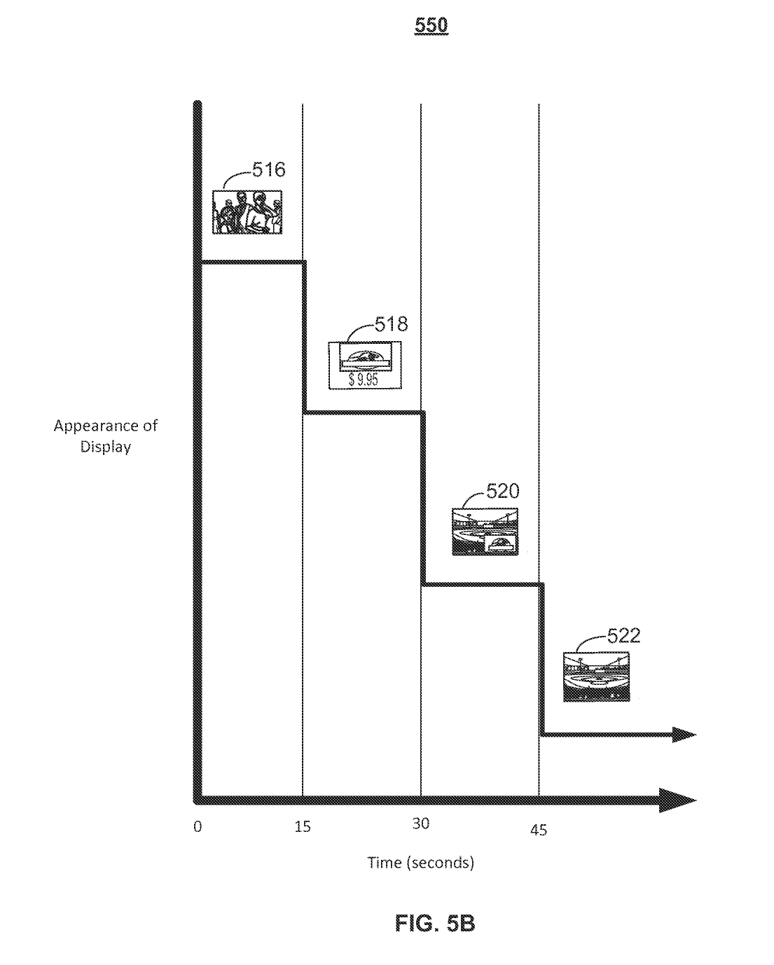

FIG. 5A is an illustrative timeline describing the events occurring at different points in time on a display screen displaying media assets and advertisements in accordance with some embodiments of the disclosure. Timeline 500 represents an embodiment of this disclosure. The events on timeline 500 may occur on any of the devices shown in FIGS. 3-4. In addition, the events of timeline 500 may be generated according to process 600, which may be executed by control circuitry 304 (FIG. 3) as instructed by the media guidance application.

At point 508, which corresponds to time equaling zero, timeline 500 indicates that a first media asset is being displayed. In some embodiments, the first media asset may be displayed on user equipment 402, 404, and/or 406 (FIG. 4). In some embodiments, the first media asset may have been selected (e.g., via display 100 (FIG. 1)) using the media guidance application. Upon receipt of the user selection (e.g., via user input interface 310 (FIG. 3)), the media guidance application, implement in user equipment (e.g., user equipment 402, 404, and/or 406 (FIG. 4)) may have generated (e.g., via control circuitry 304 (FIG. 4)) an instruction to display the media asset on display 312 (FIG. 3)).

At point 510, which corresponds to time equaling fifteen seconds, the media guidance application determines the beginning of the advertisement. In some embodiments, this may occur via a flag transmitted with the media asset or may be determined based on information received via a remote server (e.g., content source 416 (FIG. 4) and/or media guidance data source 418 (FIG. 4)) as explained above. At point 510, the advertisement is displayed on a display (e.g., display 200 (FIG. 2)). Also at point 510, the display of the first media asset terminates. For example, the display of the first media asset may have several scheduled advertisement breaks. While one or more of the advertisements in the advertisement break are displayed, the display of the first media asset is interrupted in order to display the advertisement.

At point 512, which corresponds to time equaling thirty seconds, the media guidance application receives (e.g., via user input interface 310 (FIG. 3)) a user input requesting the display of a second media asset. For example, a user may have requested a channel change or may have selected a new video to stream. In response to the user request, the media guidance application generates (e.g., using control circuitry 304 (FIG. 3)) an instruction to display the second media asset on the display screen (e.g., display 312 (FIG. 3)) of the user device (e.g., user equipment 402, 404, and/or 406 (FIG. 4)) as well as an instruction to display the advertisement in PIP display.

At point 514, which corresponds to time equaling forty-five seconds, the media guidance application determines the termination of the advertisement. For example, the media guidance application may receive a flag indicating the advertisement has terminated, as described above. Additionally or alternatively, the media guidance application may receive media guidance data indicating the termination of the advertisement as explained above. Upon determining the termination of the advertisement, the media guidance application generates (e.g., using control circuitry 304 (FIG. 3)) an instruction to no longer displayed on the display screen (e.g., display 312 (FIG. 3)) of the user device (e.g., user equipment 402, 404, and/or 406 (FIG. 4)) the advertisement in a PIP display.

Line 502 corresponds to the display (e.g., via display 312 (FIG. 3)) on a user device (e.g., user equipment 402, 404, and/or 406 (FIG. 4)) of the first media asset. Line 504 corresponds to the display (e.g., via display 312 (FIG. 3)) on the user device (e.g., user equipment 402, 404, and/or 406 (FIG. 4)) of the advertisement, and line 506 corresponds to the display (e.g., via display 312 (FIG. 3)) on the user device (e.g., user equipment 402, 404, and/or 406 (FIG. 4)) of the second media asset.

Line 502, representing the first media asset, begins at time equals zero and ends at time equals fifteen seconds, which corresponds to the points in time when the first media asset is displayed on the display of a user device. Line 504, representing the advertisement, begins at time equals fifteen seconds and terminates at time equals forty-five seconds, which corresponds to the points in time when the advertisement is displayed on the display of a user device. Line 506, representing the second media asset, begins at time equals thirty seconds and continues past time equals forty-five seconds, which corresponds to the points in time when the second media asset is displayed on the display of a user device.

From time equals thirty seconds to time equals forty-five seconds both the advertisement and the second media asset are displayed. For example, as shown by display 520 (FIG. 5C), during this time period the second media asset and the advertisement are both displayed. In some embodiments, the second media asset and/or the advertisement may be displayed in a display window on a display (e.g., display 312 (FIG. 3)) of a user device (e.g., user equipment 402, 404, and/or 406 (FIG. 4)). As described above, the display of the second media asset may include a PIP display (e.g., as shown in display 520 (FIG. 5C), may include an on-screen banner (e.g., as shown in display 100 (FIG. 1), or may include re-sizing the display of the second media asset and the advertisement (e.g., as shown in display 200 (FIG. 2)). While both the advertisement and the second media asset are displayed the sound associated with one or both may be generated. Additionally or alternatively, the sound associated with one or both may be displayed in subtitles on the display. In some embodiments, the sound associated with one or both may be generated and/played on one or more devices. For example, the sound associated with the second media asset may be heard via speakers 314 (FIG. 3) of a first user device (e.g., user equipment 402, 404, and/or 406 (FIG. 4) and the sound associated with the advertisement may be heard via speakers 314 (FIG. 3) of a second user device (e.g., user equipment 402, 404, and/or 406 (FIG. 4).

FIG. 5B is an illustrative timeline showing the appearance of a display screen displaying media assets and advertisements at various points in time in accordance with some embodiments of the disclosure. In some embodiments, timeline 550 may correspond to timeline 500. Whereas timeline 500 described the events occurring at a particular point in time, timeline 550 shows the display screen (e.g., display 312 (FIG. 3)) on a user device (e.g., user equipment 402, 404, and/406 (FIG. 4)) as it would appear at different points in time on a user display. The events on timeline 530 may occur on any of the devices shown in FIGS. 3-4. In addition, the events of timeline 530 may be generated according to process 600, which may be executed by control circuitry 304 (FIG. 3) as instructed by the media guidance application.

Timeline 550 includes display 516, display 518, display 520, and display 522. Display 516 corresponds to the display (e.g., via display 312 (FIG. 3)) on a user device (e.g., user equipment 402, 404, and/or 406 (FIG. 4)) of the first media asset. Display 518 corresponds to the display (e.g., via display 312 (FIG. 3)) on the user device (e.g., user equipment 402, 404, and/or 406 (FIG. 4)) of the advertisement. Display 520 corresponds to the display (e.g., via display 312 (FIG. 3)) on the user device (e.g., user equipment 402, 404, and/or 406 (FIG. 4)) of the second media asset with the advertisement displayed in a PIP window, and display 522 corresponds to the display (e.g., via display 312 (FIG. 3)) on the user device (e.g., user equipment 402, 404, and/or 406 (FIG. 4)) of the second media asset without the advertisement displayed in a PIP window.

Display 516, representing the first media asset begins at time equals zero and terminates at time equals fifteen seconds, which corresponds to the points in time when the first media asset is displayed on the display of a user device. In display 516, the first media asset is shown in a full-screen display. Display 518, representing the full-screen display of the advertisement, which begins at time equals fifteen seconds and terminates at time equals thirty seconds. Display 518 represents a point after the first media asset has been interrupted in order to display an advertisement, but before a user requests a different media asset.

Display 520, representing the second media asset with a PIP window of the advertisement, begins at time equals thirty seconds and terminates at time equals forty-five seconds, which corresponds to the points in time when second media asset and the advertisement are displayed on a single display of the user device. Display 518 represents a point after the user requests a different media asset, but before the advertisement (or advertisement break) is completed. In display 520, the advertisement is shown in a PIP display.

Display 522, representing the full-screen display of the second media asset begins at time equals forty-five. Display 518 represents a point after the advertisement (or advertisement break) is completed. In display 520, the PIP display is no longer shown and the second media asset is shown in a full screen.

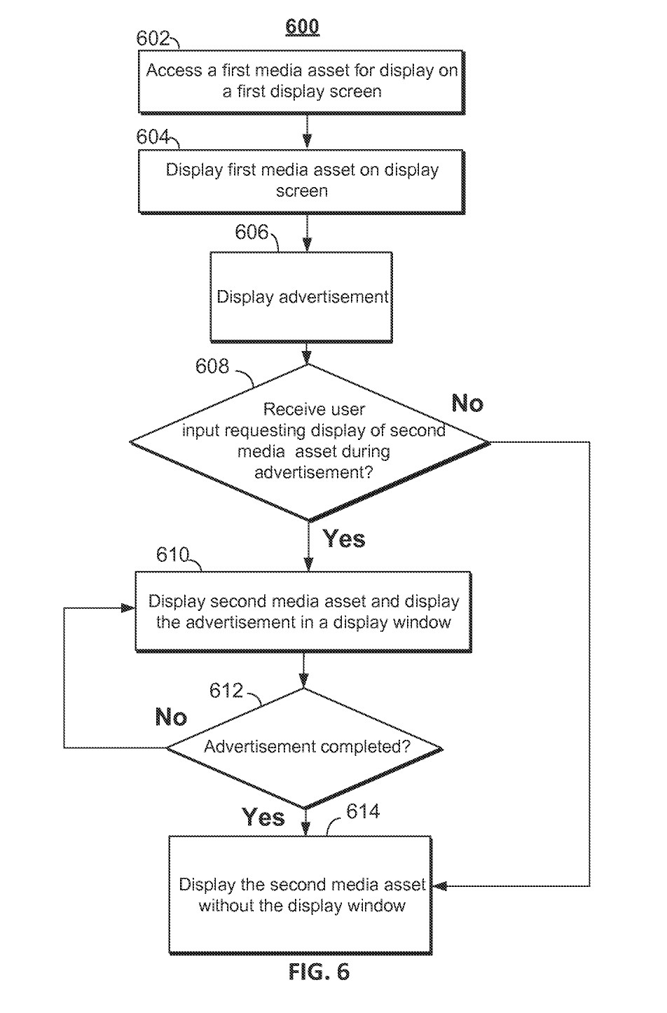

FIG. 6 is a flowchart of illustrative steps for displaying an advertisement in a display window in response to a user request to access a second media asset during the display of the advertisement in accordance with some embodiments of the disclosure. Process 600, as shown in FIG. 6, may be used to provide the displays as shown in FIGS. 1, 2, and/or 5A-B. It should be noted that process 600 or any step thereof, could be displayed on, or provided by, any of the devices shown in FIGS. 3-4. For example, process 600 may be executed by control circuitry 304 (FIG. 3) as instructed by the media guidance application.

At step 602, the media guidance application accesses a first media asset for display on a first display screen. For example, in some embodiments, in response to a user input (e.g., via user input interface 310 (FIG. 3)), the media guidance application may access a first media asset (e.g., via receiving a broadcasted channel or accessing a streaming media file located on a website) transmitted from a remote source (e.g., content source 416 (FIG. 4), media guidance data source 418 (FIG. 4)) and/or any location accessible via communications network 414 (FIG. 4)).

At step 604, the media guidance application may instruct the first media asset to be displayed on a display screen. For example, the media guidance application may instruct (e.g., via control circuitry 304 (FIG. 3)) a user device (e.g., user equipment 402, 404, and/or 406 (FIG. 4)) to access the first media asset and display the first media asset on a display (e.g., display 312 (FIG. 3)) of the user device. In some embodiments, step 604 may correspond to line 502 (FIG. 5A).

At step 606, the media guidance application may instruct the display of an advertisement. For example, the media guidance application may receive an indication (e.g., via content source 416 (FIG. 4) that an advertisement break (e.g., containing one or more advertisements) associated with the first media asset (e.g., a commercial interruption in the first media asset) is about to begin. The one or more advertisements may be displayed on a display (e.g., display 312 (FIG. 3)) on a user device (e.g., user equipment 402, 404, and/or 406 (FIG. 4)). In some embodiments, step 606 may correspond to line 504 (FIG. 5A)) between point 510 (FIG. 5A) and point 512 (FIG. 5A)).

At step 608, the media guidance application receives a user input requesting the display of a second media asset. For example, the media guidance application may receive (e.g., via user input interface (FIG. 3)) a user selection of a different media asset on a website or a user selection of a different channel or streaming media asset on a user device (e.g., user equipment 402, 404, and/or 406 (FIG. 4)). If the media guidance application determines that the request to display a second media asset does not occur during the display of the advertisement, the media guidance application may instruct (e.g., via control circuitry 304 (FIG. 3)) the display of the second media asset without the advertisement in a display window at step 614.

If the media guidance application determines that the user input requesting display of a second media asset occurs during the advertisement (e.g., based on tags or signals received with the advertisement as explained above), the media guidance application transmits instructions (e.g., via control circuitry 304 (FIG. 3)) to display the second media asset on a display (e.g., display 312 (FIG. 3)) of the user device (e.g., user equipment 402, 404, and/or 406 (FIG. 4)) at step 610. In addition, at step 610, the media guidance application transmits instructions to display the advertisement in a display window. In some embodiments, step 610 may correspond to line 504 (FIG. 5A) and line 506 (FIG. 5A) between point 512 (FIG. 5A) and point 514 (FIG. 5A).

In some embodiments, the display window may appear as an overlay (e.g., a PIP display or on-screen banner) on the display of the second media asset as displayed on the user device. In some embodiments, the display window may appear is a split screen (e.g., as shown in FIG. 2)) in the user device. In some embodiments, the display window may appear on a separate user device (e.g., a second screen device as described above).

At step 612, the media guidance application determines whether or not the advertisement is completed. For example, the media guidance application may determine whether or not a flag indicating that the advertisement was completed was received as described above. In some embodiments, the advertisement may be part of an advertisement break, in which case the media guidance application may determine whether or not the advertisement break is completed (e.g., all advertisements in the advertisement break have been displayed).

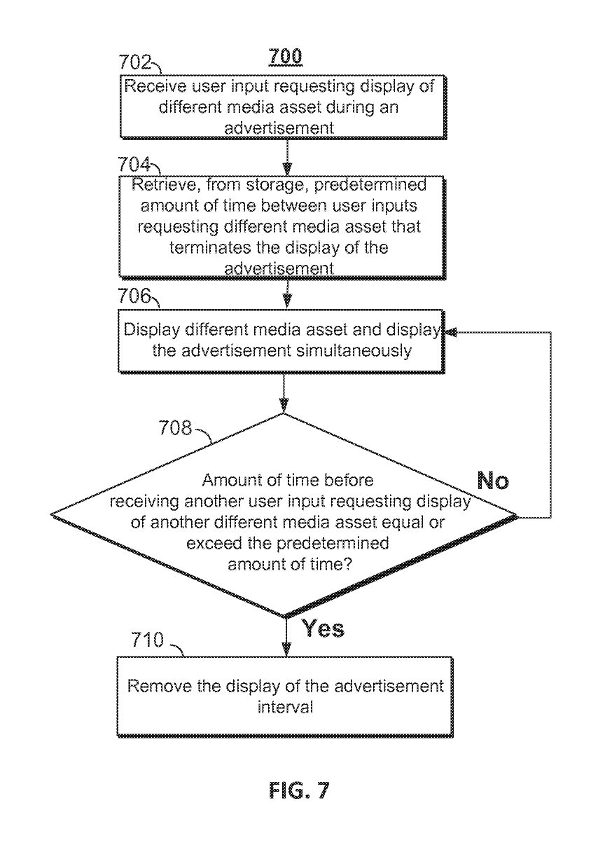

If the media guidance application determines that the advertisement is not completed, the media guidance application continues to display the second media asset and the advertisement, in a display window, on the user device at step 610. If the media guidance application determines that the advertisement is completed, the media guidance application displays the second media asset (e.g., on display 312 (FIG. 3)) without the advertisement in a display window at step 614. In some embodiments, step 614 may correspond to line 506 after point 514 (FIG. 5)). In some embodiments, the media guidance application may receive (e.g., from media guidance data source 418 (FIG. 4)) or generate (e.g., via control circuitry 304 (FIG. 3)) an instruction to remove the display window. The instruction may be based on numerous factors as described in relation to process 700 (FIG. 7) below.

It is contemplated that the steps or descriptions of FIG. 6 may be used with any other embodiment of this disclosure. In addition, the steps and descriptions described in relation to FIG. 6 may be done in alternative orders or in parallel to further the purposes of this disclosure. For example, each of these steps may be performed in any order or in parallel or substantially simultaneously to reduce lag or increase the speed of the system or method.

FIG. 7 is a flowchart of illustrative steps for determining when to remove the display of an at least one advertisement display in a display window in accordance with some embodiments of the disclosure. Process 700, as shown in FIG. 7, may be used to provide the displays as shown in FIGS. 1, 2, and/or 5A-B. It should be noted that process 700 or any step thereof, could be displayed on, or provided by, any of the devices shown in FIGS. 3-4. For example, process 700 may be executed by control circuitry 304 (FIG. 3) as instructed by the media guidance application.

At step 702, the media guidance application receives a user input (e.g., via user input interface 310 (FIG. 3)) requesting the display of a different media asset during an advertisement. For example, in some embodiments, step 702 may correspond to step 608 (FIG. 6).

At step 704, the media guidance application retrieves, from storage, predetermined amount of time between user inputs requesting different media asset that terminates the display of the advertisement. For example, upon receiving the user input, the media guidance application may determine the length of time (in seconds or number of advertisements) that the advertisement will continued to be displayed in a display window. The media guidance application may retrieve this predetermined amount of time local storage (e.g., storage 308 (FIG. 3)) or remote storage (e.g., media guidance data source 418 (FIG. 4) or any device accessible via communications network 414 (FIG. 4)).

At step 706, the media guidance application displays the different media asset and the advertisement simultaneously. For example, in some embodiments, step 706 may corresponds to step 610 (FIG. 6) or display 520 (FIG. 5B). At step 708, the media guidance application determines whether or not the amount of time before receiving another user input (e.g., via user input interface 310 (FIG. 3)) requesting display of a different media asset equal or exceed the predetermined amount of time retrieved in step 704. For example, while the media asset and the advertisement (e.g., in a display window) are displayed simultaneously, the media guidance application may receive another channel change request. For example, the user may be scanning through several channels trying to decide what program to watch.

At step 708, the media guidance application determines whether or not the amount of time before receiving another user input requesting the display of another different media asset equals or exceeds the predetermined amount of time retrieved in step 704. If the media guidance application determines that another user input requesting display of another different media asset is received before the predetermined amount of time, the media guidance application returns to step 706 and displays the another different media asset and the advertisement simultaneously. For example, the media guidance application may continue to display the advertisement simultaneously with one or more different media assets as a user scans through the different media assets (e.g., as the user channel surfs).

Upon determining that a predetermined amount of time retrieved in step 704 has been equaled or exceeded (e.g., as determined by the media guidance application or as instructed by data received from media guidance data source 418 (FIG. 4)) between receiving user inputs requesting the display of different media assets (e.g., the user has stopped scanning and has settled on a particular media asset), the media guidance application removes the display of advertisement at step 710.

In some embodiments, the media guidance application may use different, or a combination of, factors to determine when to remove the display of the advertisement. Process 700 is illustrative of one possible method and should not be taken to be limiting. For example, in some embodiments, the media guidance application may determine when to remove the display of the advertisement based on a predetermined time limit for the display of the advertisement (e.g., as determined based on a predetermined time limit retrieve from storage 308 (FIG. 3)) and/or based on an amount of advertisements (e.g., during an advertisement break) that have been displayed (e.g., as determined based on scheduling information received from content source 416 (FIG. 4)). For example, if the advertisement was part of an advertisement break scheduled to display three advertisements, the media guidance application may terminate the display of the advertisement break after the three advertisements have been displayed.

Additionally or alternatively, the media guidance application may (e.g., using control circuitry 304 (FIG. 3)) pause the display of the advertisement while a user channel surfs. For example, the media guidance application may pause the display of the advertisement upon receiving a first user input (e.g., via user input interface 310 (FIG. 3)) requesting the display of a second media asset. The media guidance application may then wait to continue the display of the advertisement (e.g., to ensure the user views the advertisement) from the point of the pause until the media guidance application determines a predetermined amount of time has been reached before receiving a second user input (e.g., via user input interface 310 (FIG. 3)) requesting the display of a third media asset. Upon determining that the predetermined amount of time has been reach, the media guidance application may generate an instruction to continue the display of the advertisement in order to ensure the user is attentive during the display of the advertisement.

It is contemplated that the steps or descriptions of FIG. 7 may be used with any other embodiment of this disclosure. In addition, the steps and descriptions described in relation to FIG. 7 may be done in alternative orders or in parallel to further the purposes of this disclosure. For example, each of these steps may be performed in any order or in parallel or substantially simultaneously to reduce lag or increase the speed of the system or method.

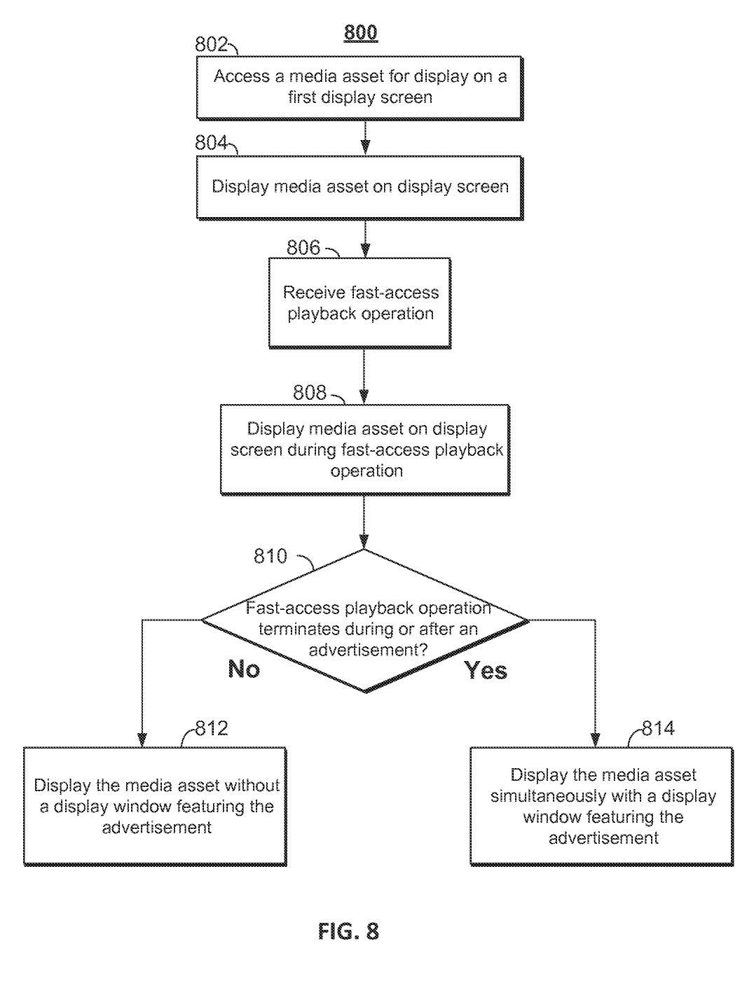

FIG. 8 is a flowchart of illustrative steps for displaying an advertisement in a display window in response to a user performing a fast-access playback operation during (or through) an advertisement in accordance with some embodiments of the disclosure. Process 800, as shown in FIG. 8, may be used to provide the displays as shown in FIGS. 1, 2, and/or 5A-B. It should be noted that process 800 or any step thereof, could be displayed on, or provided by, any of the devices shown in FIGS. 3-4. For example, process 800 may be executed by control circuitry 304 (FIG. 3) as instructed by the media guidance application.

At step 802, the media guidance application accesses a media asset for display on a first display screen. For example, in some embodiments, in response to a user input (e.g., via user input interface 310 (FIG. 3)), the media guidance application may access a media asset stored on, or available on-demand to, a user device (e.g., user equipment 402, 404, and/or 406 (FIG. 4)). For example, the media asset may be a broadcasted television program that was previously stored (e.g., via DVR technology) on a user device.

At step 804, the media guidance application may instruct the user device to display the media asset on the display screen. For example, the media guidance application may instruct (e.g., via control circuitry 304 (FIG. 3)) a user device (e.g., user equipment 402, 404, and/or 406 (FIG. 4)) to access the media asset and display the media asset on a display (e.g., display 312 (FIG. 3)) of the user device.

At step 806, the media guidance application receives a user input (e.g., via user input interface 310 (FIG. 3)) instructing the media guidance application to perform a fast-access playback operation. For example, the user may have fast-forwarded or skipped to a different part of the media asset.

At step 808 the media guidance application transmits an instruction to display the media asset on the display screen during the fast-access playback operation. For example, the media guidance application continues to the display of the media asset (albeit it in a fast-forward mode or while skipping to different parts of the media asset).

At step 810, the media guidance application determines whether or not fast-access playback operation terminates during or after an advertisement. For example, the media guidance application may analyze flags transmitted and/or embedded in the media asset, which identify the beginning and termination of one or more advertisements to determine whether or not the fast-access playback operation terminates during or after an advertisement (e.g., an advertisement was fast-forwarded through or an advertisement was skipped over).

If the media guidance application determines that the fast-access playback operation terminates during after an advertisement (e.g., an advertisement was missed), the media guidance application, upon the termination of the fast-access playback operation, instructs (e.g., via control circuitry 304 (FIG. 3)) the media asset to be displayed simultaneously with a display window featuring the advertisement (e.g., as shown by display 520 (FIG. 5B)) at step 814. If the media guidance application determines that the fast-access playback operation did not terminate during or after an advertisement (e.g., an advertisement was not missed), the media guidance application, upon the termination of the fast-access playback operation, instructs (e.g., via control circuitry 304 (FIG. 3)) the media asset to be displayed without a display window featuring the advertisement (e.g., as shown by display 522 (FIG. 5B)) at step 812.

It is contemplated that the steps or descriptions of FIG. 8 may be used with any other embodiment of this disclosure. In addition, the steps and descriptions described in relation to FIG. 8 may be done in alternative orders or in parallel to further the purposes of this disclosure. For example, each of these steps may be performed in any order or in parallel or substantially simultaneously to reduce lag or increase the speed of the system or method.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real-time. It should also be noted, the systems and/or methods described above may be applied to, or used in accordance with, other systems and/or methods.

1. A method for displaying advertisements associated with media assets, the method comprising:
receiving a request to access a first media asset on a first user device, wherein the first media asset is associated with an advertisement that is displayed during the first media asset;
in response to the request, generating for display the first media asset;
receiving a user input requesting to stop accessing the first media asset and to start accessing a second media asset;
determining that the user input was received during the advertisement; and
in response to determining that the user input was received during the advertisement, generating for display the advertisement in a display window simultaneously with the second media asset.

2. (canceled)

3. The method of claim 1, further comprising:
generating for display the display window on a second user device; and
generating for display the second media asset on the first user device.

4. The method of claim 1, wherein the display window is a Picture-In-A-Picture (“PIP”) display, or an on-screen banner, or a split screen display.

5. The method of claim 1, further comprising determining when to remove the advertisement based on a predetermined time limit.

6. The method of claim 1, further comprising determining when to remove the advertisement based on an amount of advertisements that have been displayed.

7. The method of claim 1, further comprising determining when to remove the advertisement based on an amount of time between receiving user inputs requesting different media assets.

8. The method of claim 1, further comprising determining when to remove the advertisement based on an amount of time the advertisement was displayed before the user input.

9. The method of claim 1, further comprising:
pausing the advertisement;
determining a predetermined amount of time has been reached before receiving a second user input requesting the display of a third media asset; and
in response to determining the predetermined amount of time has been reached before receiving the second user input requesting the display of the third media asset, resuming the advertisement.

10. The method of claim 1, further comprising:
generating for display the second media asset simultaneously with the display window, wherein the display window comprises a Picture-In-A-Picture (“PIP”) display overlaid on the second media asset;
determining the advertisement has been displayed for a predetermined amount of time; and
in response to determining the advertisement has been displayed for a predetermined amount of time, removing the display window overlaid on the second media asset.

11. A system for displaying advertisements associated with media assets, the system comprising control circuitry configured:
receive a request to access a first media asset on a first user device, wherein the first media asset is associated with advertisement that is displayed during the first media asset;
in response to the request, generate for display the first media asset;
receive a user input requesting to stop accessing the first media asset and to start accessing the second media asset;
determine that the user input was received during the advertisement on the first user device; and
in response to determining that the user input was received during the advertisement on the first user device, generate for display the advertisement in a display window simultaneously with the second media asset.

12. (canceled)

13. The system of claim 11, wherein the control circuitry is further configured to:
generate for display the display window on a second user device; and
generate for display the second media asset on the first user device.

14. The system of claim 11, wherein the display window is a Picture-In-A-Picture (“PIP”) display, an on-screen banner, or a split screen display.

15. The system of claim 11, wherein the control circuitry is further configured to determine when to remove the advertisement based on a predetermined time limit.

16. The system of claim 11, wherein the control circuitry is further configured to determine when to remove the advertisement based on an amount of advertisements that have been displayed.

17. The system of claim 11, wherein the control circuitry is further configured to determine when to remove the advertisement based on an amount of time between receiving user inputs requesting different media assets.

18. The system of claim 11, wherein the control circuitry is further configured to determine when to remove the advertisement based on an amount of time the advertisement was displayed before the user input.

19. The system of claim 11, wherein the control circuitry is further configured to:
pause the advertisement;
determine a predetermined amount of time has been reached before receiving a second user input requesting the display of a third media asset; and
in response to determining the predetermined amount of time has been reached before receiving the second user input requesting the display of the third media asset, resume the advertisement.

20. The system of claim 11, wherein the control circuitry is further configured to:
generate for display the second media asset simultaneously with the display window, wherein the display window comprises a Picture-In-A-Picture (“PIP”) display overlaid on the second media asset;
determine the advertisement has been displayed for a predetermined amount of time; and
in response to determining the advertisement has been displayed for a predetermined amount of time, removing the display window overlaid on the second media asset.

21. A system for displaying advertisements associated with media assets, the system comprising:
means for receiving a request to access a first media asset on a first user device, wherein the first media asset is associated with advertisement that is displayed during the first media asset;
means for generating for display the first media asset in response to the request;
means for receiving a user input requesting to stop accessing the first media asset and to start accessing the second media asset;
means for determining that the user input was received during the advertisement; and
means for generating for display the advertisement in a display window simultaneously with the second media asset in response to determining that the user input was received during the advertisement.

22. (canceled)

23. The system of claim 21, further comprising:
means for generating for display the display window on a second user device; and
means for generating for display the second media asset on the first user device.

24. The system of claim 21, wherein the display window is a Picture-In-A-Picture (“PIP”) display, an on-screen banner, or a split screen display.

25. The system of claim 21, further comprising means for determining when to remove the advertisement based on a predetermined time limit.

26. The system of claim 21, further comprising means for determining when to remove the advertisement based on an amount of advertisements that have been displayed.

27. The system of claim 21, further comprising means for determining when to remove the advertisement based on an amount of time between receiving user inputs requesting different media assets.

28. The system of claim 21, further comprising means for determining when to remove the advertisement based on an amount of time the advertisement was displayed before the user input.

29. The system of claim 21, further comprising:
means for pausing the advertisement;
means for determining a predetermined amount of time has been reached before receiving a second user input requesting the display of a third media asset; and
in response to determining the predetermined amount of time has been reached before receiving the second user input requesting the display of the third media asset, means for resuming the advertisement.

30. The system of claim 21, further comprising:
means for generating for display the second media asset simultaneously with the display window, wherein the display window comprises a Picture-In-A-Picture (“PIP”) display overlaid on the second media asset;
means for determining the advertisement has been displayed for a predetermined amount of time; and
in response to determining the advertisement has been displayed for a predetermined amount of time, means for removing the display window overlaid on the second media asset.
